(19) United States
(12) Patent Application Publication
(10) Pub. No.: US 2007/0156535 A1
(43) Pub. Date: Jul. 5, 2007

(54) Cancellation of transactions

(76) Inventors: Thomas Hoffmann, Romerberg (DE); Dietmar Nowotny, Dielheim (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/323,857

(22) Filed: Dec. 30, 2005

(51) Int. Cl. G06Q 20/00

(52) U.S. Cl. 705/16

(57) ABSTRACT

Cancellation of transactions is detected in a business operations system, and a cancellation message uniquely identifying an operational document describing the transaction is created. The cancellation message is sent to various components in the business operations system and to other systems as desired. The receiving entity is free to select actions taken in response to the cancellation. In one embodiment, a primary copy of the operational document, referred to as prima nota, is referenced by a unique internal reference identifier. In further embodiments, the cancellation message may also reference prima nota of a cancellation document.

### BACKGROUND

In complex business management systems, transactions may be handled by many different parts of the system. Operations components of systems may be responsible for receiving orders, shipping, creating invoices, tracking payments and providing information to an accounting system. Such systems can be very complex, and it is difficult to track business transactions that may flow through the system.

The creation of an invoice or other transaction may have ramifications throughout the system. Thus, when an invoice is cancelled, there is a need for different parts of the system to be informed, and to take appropriate actions to ensure that the cancellation is properly handled. It can be difficult to track all everything that may need changing in the face of receiving a cancellation. Further, there can be difficulty in establishing a clear semantical distinction between credit memo and a cancellation. This may result in redundant data and a lack of clarity in appropriate responses to a cancellation.

### SUMMARY

Cancellation of transactions is detected in a business operations system, and a cancellation message uniquely identifying an operational document describing the transaction is created. The cancellation message is sent to various components in the business operations system and to other systems as desired. The receiving entity is free to select actions taken in response to the cancellation.

### BRIEF OF THE DRAWINGS

FIG. 1 is a block diagram illustration of a value chain with prima nota and single point inventory objects according to an example embodiment.

FIG. 2 is a flow chart illustrating updating of inventory objects according to an example embodiment.

FIG. 3 is a flow chart illustrating component operations in a value chain of components according to an example embodiment.

FIG. 4 is a flow chart illustrating cancellation of a transaction according to an example embodiment.

FIG. 5 is a block diagram of a computer system for implementing methods of the present invention according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software consists of computer executable instructions stored on computer readable media such as memory or other type of storage devices. The term “computer readable media” is also used to represent any means by which the computer readable instructions may be received by the computer, such as by different forms of electromagnetic transmissions. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

Cancellation of a business document, such as an invoice, shipments or goods movement for example is performed by the use of messages to various components. The messages reference a prima nota, or primary document number of the invoice, and leaves it up to the component receiving the message as to how to process the cancellation. A document resulting in the cancellation, such as a credit memo may also become a prima nota with its own reference number, which may also be communicated in the messages informing components of the cancellation.

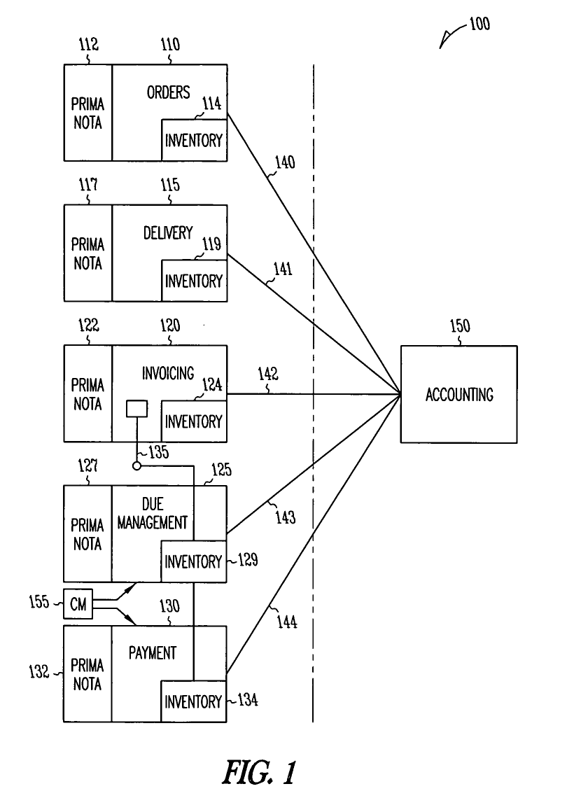

FIG. 1 is a block diagram illustration of a value chain 100 with prima nota and single point inventory objects according to an example embodiment. Selected components in the value chain comprise an orders component, 110, a delivery component 115, an invoicing component 120, a due management component 125 and a payment component 130. Orders component 110 may include prima nota 112 and an order inventory object 114. The prima nota 112 consists of images of original business documents, such as actual customer orders and contracts in one embodiment. These are the original business documents, and in one embodiment, are assigned a unique internal identification or representation such as a string of numbers and/or characters, to ensure proper referencing. While such prima nota 112 are the primary business documents, copies of them may be provided if desired.

Order inventory object 114 may include an inventory of all current unshipped orders in one embodiment. It is updated by the use of messages generated as a result of transactions. A transaction may be performed by the orders component 110 in response to receipt of an order. A message to update the inventory object 114 may also result from a delivery transaction via delivery component 115.

Deliver component 115 may also include prima nota 117 that contains primary business documents, such as delivery documents, and a delivery inventory 119, which again may be updated via messages generated by transactions from one or more components.

Invoicing component 120 may also include prima nota 122 that contains primary copies of invoices and other business documents related to functions that the invoicing component 120 performs. Invoicing component 120 may not contain a separate inventory object. It reuses the inventory of the due management component 129. Transactions may result in increases and reductions in the inventory of inventory object 129.

Due management component 125 may also include prima nota 127, such as documents related to amounts due from business partners, collections notices, etc. Due management component 125 may also include a due inventory object that represents amounts due from business partners. It may be updated via messages resulting from transactions in various components, such as invoicing via the invoicing component as represented by line 135. It may also be updated by messages generated from payments received via payment component 130.

Payment component 130 may also include prima nota 132, such as documents related to payments. Payments may take many different forms, such as cash, check, money order, credit card, offsets, and electronic funds transfer. The prima nota may be scanned copies of checks, or associated communications with such payments. The payments are transactions that are processed by the payment component 130 and result in messages incrementing and decrementing a payment register inventory object 134.

In one embodiment, the components perform transactions that modify one or more inventory objects, and also may result in communications of such transactions in the form of messages as indicated at 140, 141, 142, 143 and 144 being sent to a separate accounting/finance system 150. The business operations 100 and accounting/finance system 150 are separate systems that communicate back and forth via messages. In one embodiment, the business operations system 100 is a cash based system, where cash is calculated in real time. The accounting system may operate on an accrual basis. By using messages between these two different systems, and keeping business documents and inventory separate in the operations system, each system is free to select how to handle transactions.

One result of this separation is that a cash management finction 155, which may not be associated with any of the listed components, may quickly obtain information on the overall cash position of a business implemented by the components. Two inventory objects, the due management inventory object 129 and the payment register inventory object 134 contain representations of a substantial percentage of the cash position of the business. In one embodiment, it is approximately 80% of the cash position of the business. Thus, in a simple operation involving only two messages to these inventory objects, a good indication of the cash position of the business is easily obtained.

FIG. 2 is a flow chart illustrating updating of inventory objects according to an example embodiment. At 210, payments due are tracked in a single point of inventory payments due inventory object. Transactions resulting in payments due, such as the creation and sending of an invoice to a business partner result in updating of the payments due inventory object. Such updates are caused by messages that are received by the object and invoke methods on the object to increment or decrement payments due. Further methods may be used to obtain totals from the inventory object. In one embodiment, such totals are representative of the cash represented in the object.

At 220, payments received are tracked in a single point of inventory payment registry inventory object. As the payments are received by a component, messages are generated to increment or decrement the inventory payment registry inventory object. Such payments may be payments in full, or partial payments, and the inventory object is modified correspondingly. Further methods may be used to obtain totals from the inventory object. In one embodiment, such totals are representative of the cash represented in the object.

At 230, such updating of the payments due inventory object and the payment registry received inventory object is done via messages generated in response to transactions. As indicated above, the transactions may be related to invoices being generated, and invoices being paid partially or fully. In further embodiments, components may send messages resulting from transactions to the separate accounting system, which may be based on a different accounting method.

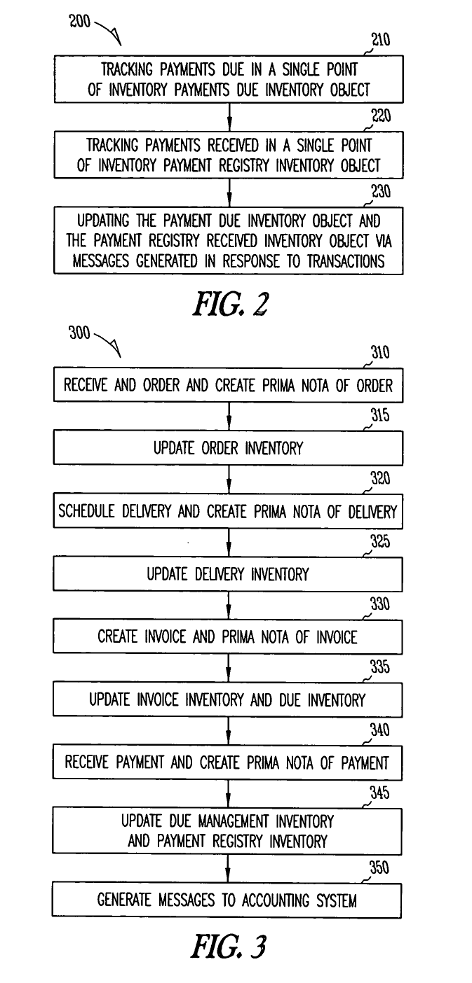

FIG. 3 is a flow chart illustrating component operations in a value chain of components according to an example embodiment. At 310, an order is received and prima nota of the order may be created. The prima nota may consist of a scanned or electronic copy of the order in one embodiment. At 315, the order inventory may be updated. At 320, a delivery of the order may be scheduled, and prima nota of delivery documents may be created. At 325, the delivery inventory may be updated. At 330, an invoice and prima nota for the invoice may be created. The due inventory may be updated at 335. When payment is received, prima nota of payment may be created, and at 345, due management inventory and payment registry inventory may be updated. Messages to the accounting system may be generated as a result of selected transactions at 350.

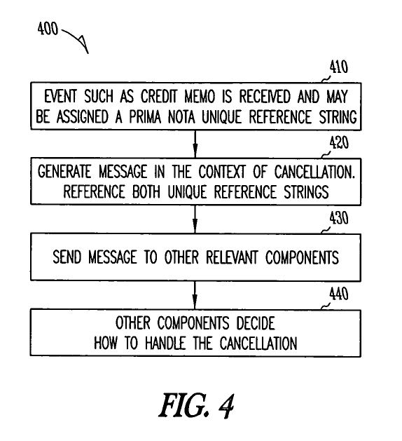

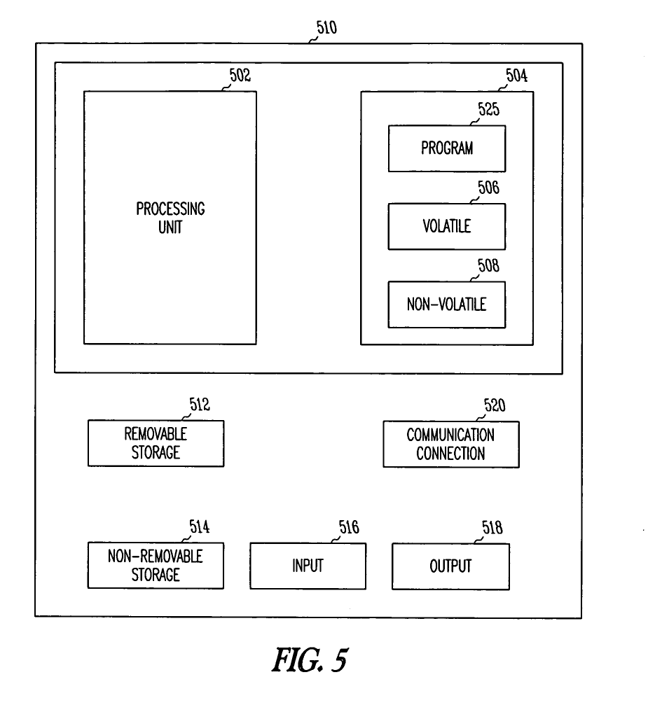

One example of a complete cancellation involves the receipt of a full credit memo that clearly cancels an invoice, as illustrated in a process 400 flowchart in FIG. 4. As indicated above, the prima nota for the invoice is identified by a unique reference string. The credit memo is received at 410, and may be assigned a prima nota internally unique reference number or string, which is different from the invoice prima nota. The credit memo in one embodiment is just one event that may be detected that results in a cancellation of the invoice. Other events may result in full cancellation of an invoice, or other type of transaction. At 420, a message is generated in the context of cancellation. The message may reference both of the unique reference strings or identifiers of the invoice prima nota and the credit memo prima nota. The message is sent to other relevant components at 430. As other components, such as due management component 125 and accounting system 150 may have created secondary documents based on the original invoice, the unique references to the prima nota invoice and credit memo allows the receiving entity or component to connect the secondary documents to the prima nota, and to decide how to handle the cancellation on their own at 440.

This capability can be helpful when dealing with the independent accounting system 150. In one example, an invoice may be posted in the accounting system 150 in December, and the books may be closed by the time a cancellation occurs in January. It would not be helpful to have the component on the business operations side that received the cancellation indicate how the accounting system 150 should handle the cancellation. It may not be possible to reopen the books from December. The method of sending a message that uniquely identifies prima nota from the operations side enables the accounting system to precisely identify the business transactions and potential related secondary documents that it has created, and then decide how to handle the cancellation. It may result in the books being reopened or restated, or it may just be entered into the books in January. The handling of such a cancellation may also be performed according to individual business conditions or rules.

In one embodiment, cancellation are performed on primae noate only. They create a new prima nota unique reference number and reference back to the prima nota which was cancelled. Messages carrying cancellations work by reference, so that no values are transported redundantly. The receiver is free to choose the appropriate strategy to cancel its data, such as the cancellation of accounting documents in closed periods, entries in trade receivables/payables may be cancelled by undoing a clearing and canceling of the original entry. Due management may reopen an already cleared item before canceling it. More flexibility is provided to the receiving components in handling the cancellation.

A block diagram of a computer system that executes programming for performing the above functions is shown in FIG. 5. In one embodiment, multiple such computer systems are utilized in a distributed network to implement multiple components in a transaction based environment. An object oriented architecture may be used to implement such functions and communicate between the multiple systems and components. One example computing device in the form of a computer 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 502 of the computer 510. A hard drive, CD-ROM, and RAM are some examples of articles including a computer-readable medium. The term “computer readable medium” is also used to represent electromagnetic transmission of the software. For example, a computer program 525 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 510 to provide generic access controls in a COM based computer network system having multiple users and servers.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method comprising:
detecting a cancellation of a transaction;
creating a cancellation message uniquely identifying an operational document describing the transaction; and
sending the message.

2. The method of claim 1 wherein the operational document describing the transaction comprises prima nota.

3. The method of claim 2 wherein the prima nota of the transaction comprises a unique internal reference identifier.

4. The method of claim 3 wherein the transaction comprises an invoice.

5. The method of claim 4 wherein the prima nota comprises a primary copy of the invoice.

6. The method of claim 1 and further comprising creating prima nota of a cancellation.

7. The method of claim 6 wherein the cancellation comprises a credit memo evidencing full cancellation.

8. The method of claim 6 wherein the cancellation message contains a unique internal identifier of prima nota describing the transaction and a unique internal identifier of prima nota describing the cancellation.

9. The method of claim 1 wherein the cancellation message is generated by a component of a business operations system.

10. The method of claim 9 wherein the cancellation message is sent to other components of the business operations system.

11. The method of claim 9 wherein the cancellation message is sent to an accounting system that is separate from the business operations system.

12. The method of claim 9 wherein an entity receiving the cancellation message is able to uniquely identify the transaction to be cancelled and handle the cancellation in accordance with its own rules.

13. A method comprising:
assigning a first unique reference identifier to a transaction;
assigning a second unique reference identifier to a cancellation of the transaction; and
sending a cancellation message to a separate accounting system identifying the first unique reference number and the second unique reference number.

14. The method of claim 13 wherein a transaction is defined by an operational document.

15. The method of claim 14 wherein a primary copy of the operational document comprises prima nota that is identified by the first unique reference identifier.

16. The method of claim 15 wherein the operational document comprises an invoice.

17. The method of claim 13 wherein the cancellation message is generated by a component of a business operations system and wherein the cancellation message is sent to another component of the business operations system.

18. The method of claim 17 wherein the cancellation message is sent to an accounting system that is separate from the business operations system.

19. The method of claim 17 wherein the cancellation message is sent to a due management component of the business operations system.

20. A computer readable medium having instructions for causing a computer to perform a method comprising:
detecting a cancellation of a transaction;
creating a cancellation message uniquely identifying an operational document describing the transaction; and
sending the cancellation message.
